(19) United States
(12) Patent Application Publication
(10) Pub. No.: US 2009/0173808 A1
(43) Pub. Date: Jul. 9, 2009

(54) Airbrush structure

(76) Inventor: Hsiu-Chun Chen, Taipei County (TW)

Correspondence Address: BACON & THOMAS, PLLC, 625 SLATERS LANE, FOURTH FLOOR, ALEXANDRIA, VA, 22314-1176, US

(21) Appl. No.: 12/003,878

(22) Filed: Jan. 3, 2008

(51) Int. Cl. B05B 11/04

(52) U.S. Cl. 239/328

(57) ABSTRACT

An airbrush, comprising an external cannular tube encasing an air compressor within one terminal of the external cannular tube and a painting pin configured in the external cannular tube, wherein an air ductile is provided between the painting pin and the external cannular tube and the painting pin further comprises a cannular pin, a liquid storage unit configured inside the cannular pin and a pin core having one terminal extending out of the external cannular tube and the other terminal connecting with the liquid storage unit for absorbing and containing liquid pigment storied in the liquid storage unit. Therefore, air injecting from the external cannular tube pressured by the air compressor would take liquid segment on surface of the pin core put atomizingly and sprinkle liquid segment from the other terminal of the cannular external tube.

### TECHNICAL FIELD

The present invention relates to an airbrush structure, and particularly to an airbrush structure applying to sprinkle atomizing segment from the airbrush manually.

### BACKGROUND ART

Conventional airbrush comprises a painting pin with a pigments cup, wherein a nozzle is configured within one end of the airbrush and an air intake is configured within the other end of the airbrush so as to inject air into the airbrush through the air intake and sprinkle pigments flowing into the airbrush from the cup out of the nozzle.

However, conventional airbrush is constructed by complex structure and with high cost. In addition, the airbrush and the cup must be cleaned carefully to avoid the internal ductile from jams caused by remaining pigment and color mix of pigment when pigments with different colors are replaced interlacingly.

Moreover, conventional airbrush is only suitable for skill in the art but not for common child since conventional airbrush must be operated at least with sort of operating abilities.

### SUMMARY OF THE INVENTION

For solving conventional problems, the present invention mainly provides an airbrush suitable for common people or child. Moreover, it's an airbrush, with a simple structure, easy to be employed.

Accordingly, the present invention provides an airbrush structure for implementing said purposes, comprises:

an external cannular tube having an air intake and a nozzle;

an air compressor, having an encasing connector for encasing one end of the external cannular tube, is capable of injecting air compressed by an external force into the external cannular tube through the air intake and exhausting compressed air out the external cannular tube through the air intake;

a painting pin, configured inside the external cannular tube, having an air ductile for passing thorough air current and further comprising a cannular pin, a liquid storage element configured inside the cannular pin encasing an air compressor within one terminal of the external cannular tube and a painting pin configured in the external cannular tube, wherein an air ductile is provided between the painting pin and the external cannular tube and the painting pin further comprises a cannular pin, a liquid storage unit configured inside the cannular pin and a pin core having one end extending out of the external cannular tube and the other terminal connecting with the liquid storage unit for absorbing and containing liquid pigment storied in the liquid storage unit.

Accordingly, air injecting from the external cannular tube pressured by the air compressor would take liquid pigment on the surface of the pin core out the surface atomizingly and sprinkle liquid pigment from the nozzle of the cannular external tube.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates an isometric view of an airbrush structure according to one embodiment of the present invention.

FIG. 2 illustrates an isometric exploded view of the airbrush structure according to one embodiment of the present invention.

FIG. 3 illustrates a cross-section view in A-A section of the airbrush structure according to one embodiment of the present invention.

FIG. 4 illustrates a view of the practice application of the airbrush structure according to one embodiment of the present invention.

FIG. 5 illustrates an isometric exploded view of a painting pin according to one embodiment of the present invention.

FIG. 6 illustrates an operating diagram of the painting pin configuring with a cover is put into water according to one embodiment of the present invention.

FIG. 7 illustrates an operating diagram of the painting pin configuring without a cover is put into water according to one embodiment of the present invention.

FIG. 8 illustrates an isometric view of the airbrush structure combined with different shapes of the air compressor according to one embodiment of the present invention.

### DESCRIPTION OF THE EMBODIMENT

Reference will now be made in detail to the embodiments of the present invention, an air intake valve apparatus for pneumatic gun. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

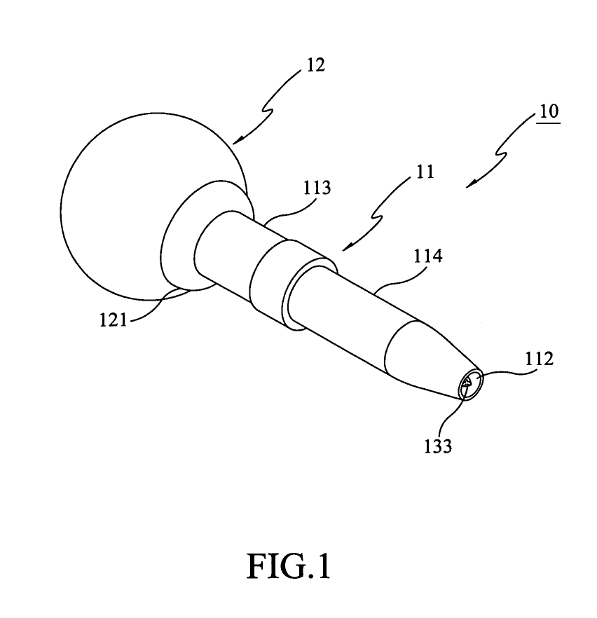

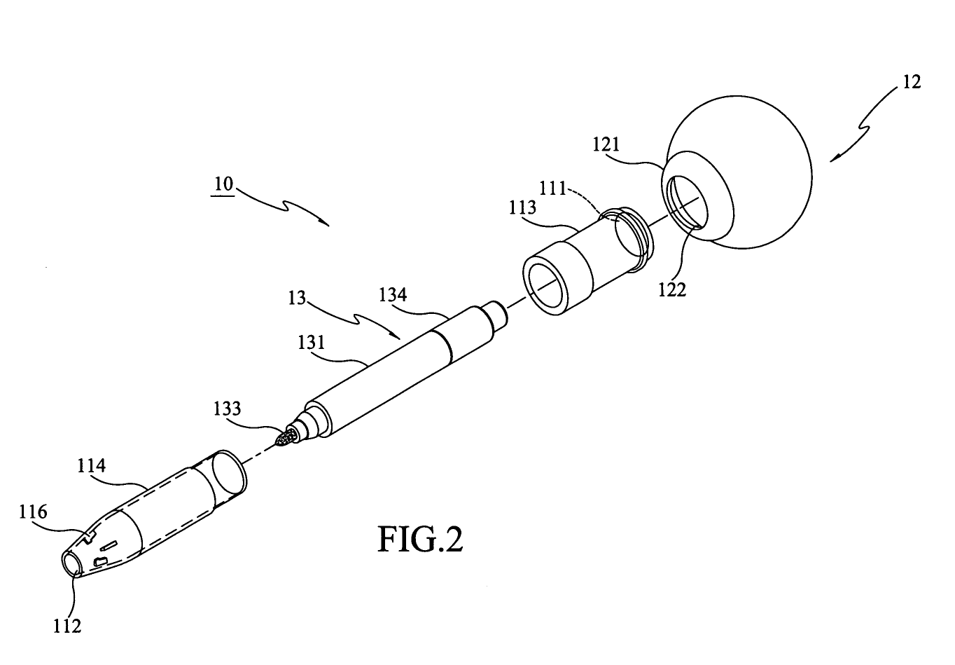

Please referring to FIG. 1 and FIG. 2 simultaneously, an airbrush 10 according to one embodiment of present invention is illustrated. The airbrush 10 mainly comprises an external cannular tube 11, an air compressor 12 encasing one end of the external cannular tube 11 and a painting pin 13 configured inside the external cannular tube 11.

Said external cannular tube 11 is a tube with a pivotally parallel cannular channel and capable of encasing the air compressor 12. The external cannular tube 11 further has a first end with an air intake 111 and a second end with a nozzle 112 for sprinkling pigment.

The external cannular tube 11 could further consist of a plurality of encasing tube. In this embodiment, the external cannular tube 11 is consisted by a first encasing tube 113 and a second encasing tube 114.

The air compressor 12 has an encasing connector 121 for encasing the first end of the external cannular tube 11, wherein a circular groove 122 is configured inside the encasing connector 121 and a protruding ring 115 is configured outside the external cannular tube 11. Therefore, the protruding ring 115 is embedded with the circular groove 122 so as to fix the connection state between the air compressor 12 and the external cannular tube 11.

The air compressor 12 is composed of flexible material such as rubber or soft plastic so as to make the compressor 12 with a characteristic of deformation under an external force and restoring after the external force been relieved.

Therefore, after the air compressor 12 is pushed by the external force, air could be injected into the external cannular tube 11 and exhausted out of the external cannular tube 11 in the end.

With regard to the painting pin 13, it is consisted of a cannular pin 131, a liquid storage unit 132 configured inside the cannular pin and a pin core 133, having one terminal extending out of the cannular pin 131 and is used with absorbing and containing liquid pigment storied in the liquid storage unit 132.

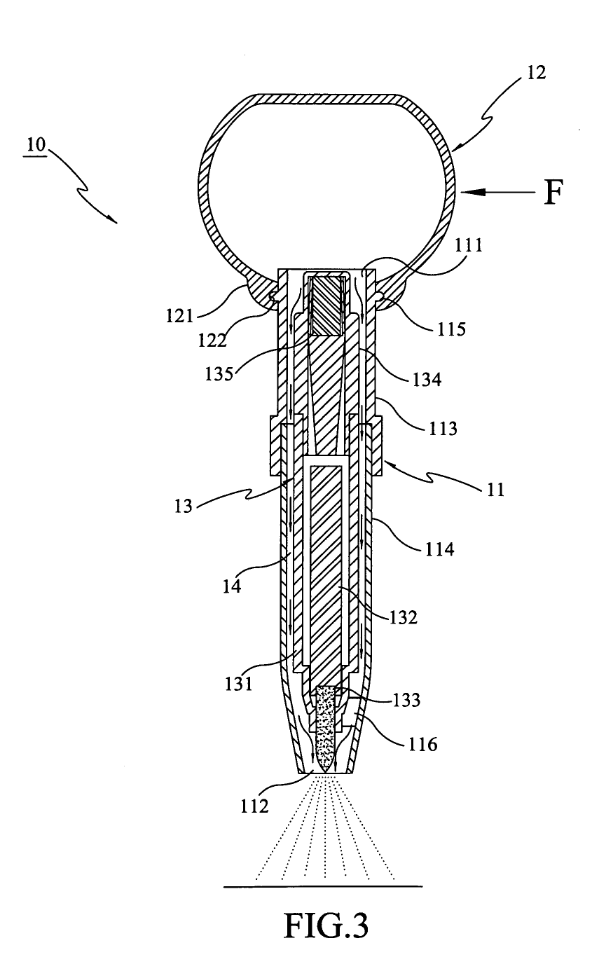

Please referring to FIG. 1 and FIG. 3 simultaneously, it is found that a plurality of positioning frame 116 for supporting and fixing the cannular pin 131 of the painting pin 13 is configured on the bottom surface of the external cannular tube 11 so as to maintain a space between the painting pin 13 and the external cannular tube 11 to form an air ductile 14 for passing air current through.

As described above, the airbrush 10 could inject air stored in the air compressor 12 into the air ductile 14 between the external cannular tube 11 and the painting pin 13 through the air intake 111 and forward to the direction of the nozzle 112 of the external cannular tube 11.

Before air reaches the nozzle 112, it would contact the pin core 133 of the painting pin 13 and take liquid pigment on the surface of the pin core 133 out of the surface atomizingly and sprinkle liquid pigment from the nozzle 112 of the cannular external tube 11.

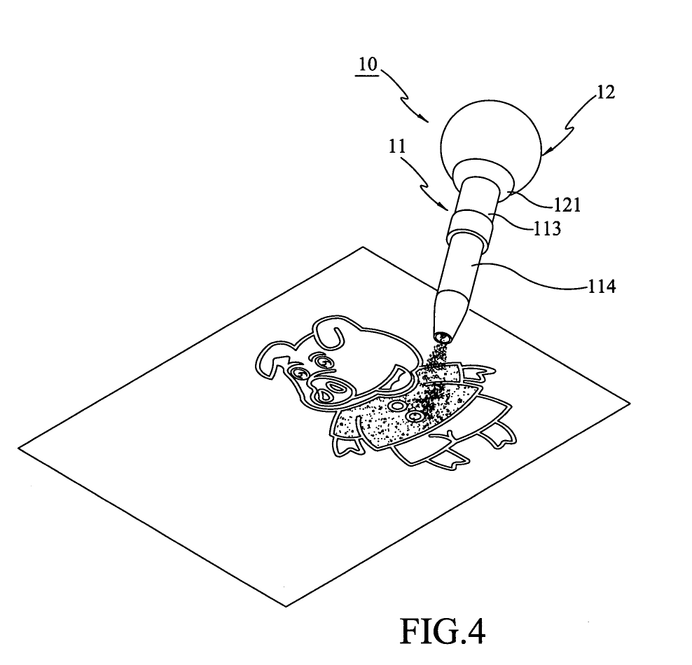

Through pushing the air compressor 12 repeatingly, atomizing pigment could be sprinkled from the nozzle 112 so as to reach the purpose of wide area painting and enjoy the fun for airbrush painting (as illustrated in FIG. 4). According to above descriptions, the present invention is an easy-using airbrush with a simple structure, which is suitable for the use of common people or child. In addition, the painting pin 13 applying to the airbrush 10 of present invention is capable of replacing by other painting pin with different color under the demands of uses. Through mix between atomizing pigments with different color, exuberant and variable characteristics of color combinations could be reached. To implement above function, user only needs to take the first encasing tube 113 and the second encasing tube 114 apart, and re-encase the first encasing tube 113 and the second encasing tube 114 after the painting pin 13 is replaced.

For the convenience to acknowledge the color of the pigment inside the painting pin 10, the cannular external tube 11 of the painting pin 10 could be implemented by transparent material for making user could acknowledge the color of the pigment inside the painting pin 13 or the pin core 133 from outside of the cannular external tube 11.

In addition, the liquid storage unit 132 configured in the painting pin 13 is suggested using water-soluble pigment so as to wash any pigment sprinkled on any material surface to reach purposes of re-use and environment protection.

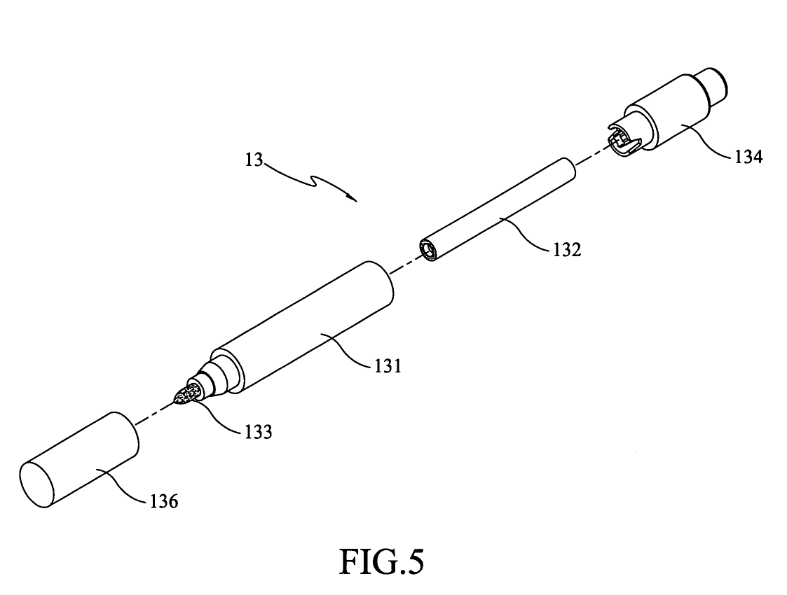

Please referring to FIG. 3 and FIG. 5 simultaneously, an isometric exploded view of the painting pin 13 is illustrated. As illustrated, the cannular pin 131 of the painting pin 13 has a first end for providing pin core 133 extending out the cannular pin 131 and a second end connecting with a detachable cover 134, wherein a weight adjusting mass 135 is further configured in the cover 134.

For avoiding pigment stored in the liquid storage unit 132 to volatilize, the cover 136 could be closed to isolate the pin core 133 exploded out the cannular pin 131 from air.

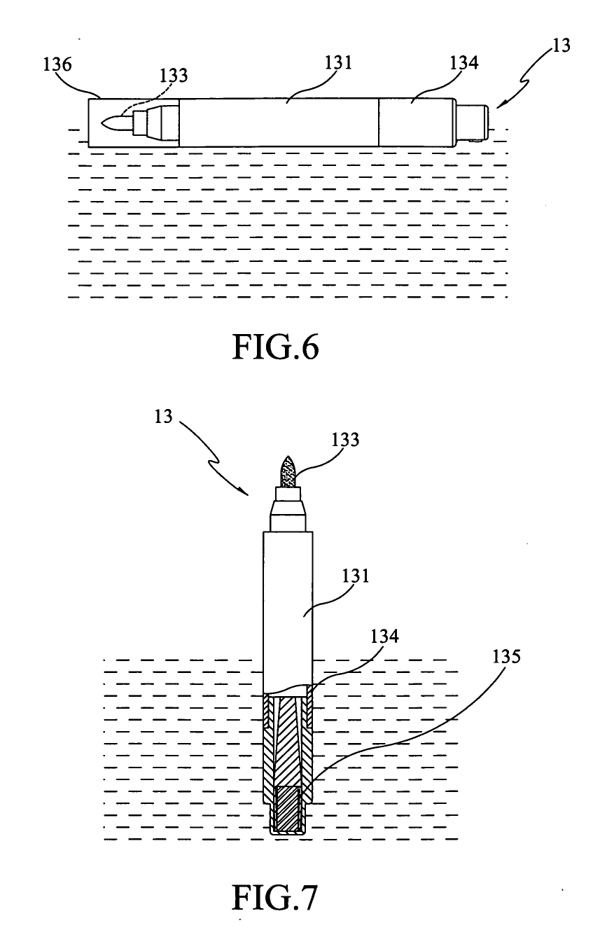

Please referring to FIG. 6 and FIG. 7, states illustrates the painting pin is covered with the cover 136 and put into water respectively; Since the weight adjusting mass 135 is configured within one end of the painting pin 13, the middle section of the cannular painting pin 13 would lay on the surface of water parallelly when the other end of the painting pin 13 is covered by the cover 136. When the cover 136 is taken apart from the painting pin 136, the end of the painting pin 13 with the weight adjusting mass 135 sinks into water so that the other end of the pin core 133 flows upon the water.

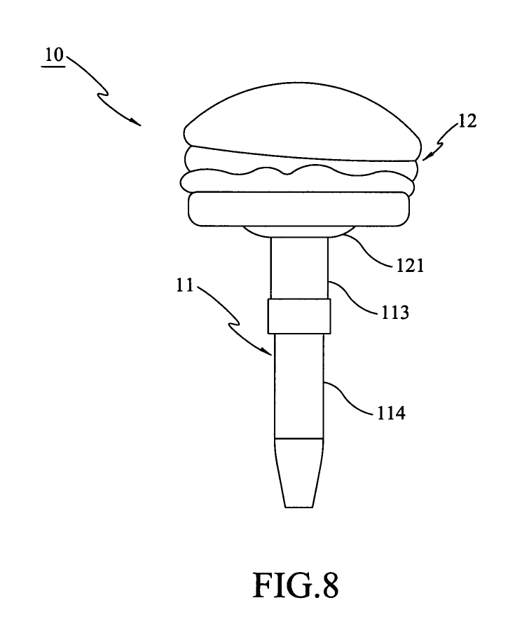

Please referring to FIG. 8, shapes of the air compressor 12 could be shaped as any kind of toy, such as dolls and cars, for increasing aesthetic feeling and entertainment effects of the airbrush.

Foregoing descriptions and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. an airbrush structure, comprising:
an external cannular tube having an air intake and a nozzle;
an air compressor, having an encasing connector for encasing one end of the external cannular tube, is capable of injecting air compressed by an external force into the external cannular tube through the air intake and exhausting compressed air out the external cannular tube through the air intake; and
a painting pin, configured inside the external cannular tube, having an air ductile for passing air current through and further comprising a cannular pin, a liquid storage element configured inside the cannular pin encasing an air compressor within one terminal of the external cannular tube and a painting pin configured in the external cannular tube, wherein an air ductile is provided between the painting pin and the external cannular tube and the painting pin further comprises a cannular pin, a liquid storage unit configured inside the cannular pin and a pin core having one end extending out of the external cannular tube and the other terminal connecting with the liquid storage unit for absorbing and containing liquid pigment storied in the liquid storage unit.

2. As cited in claim 1, wherein the external cannular tube further comprising a plurality of encasing tubes.

3. As cited in claim 2, wherein the external cannular tube is consisted of a first encasing tube and a second encasing tube and the first encasing tube and the second encasing tube are capable of encasing each other.

4. As cited in claim 1, wherein the external cannular tube is composed of transparent material.

5. As cited in claim 1, wherein a plurality of positioning frames are configured on the tube surface of the external cannular tube to support sand fix the painting pin.

6. As cited in claim 1, wherein the external cannular tube, wherein the cannular pin has a first end for extending the pin core out the cannular pin and a second end connecting with a cover.

7. As cited in claim 6, wherein a weight adjusting mass is further configured in the cover.

8. As cited in claim 1, wherein a circular groove is configured inside the encasing connector of the air compressor and a protruding ring is configured outside the external cannular tube and the protruding ring and the circular groove is capable of embedding each other.

9. As cited in claim 1, wherein the air compressor is a flexible material with a characteristic of deformation under an external force and restoring after the external force been relieved.

10. As cited in claim 1, wherein the air compressor is composed of flexible material selecting from a group of rubber and soft plastic.
